(19) United States
(12) Patent Application Publication
(10) Pub. No.: US 2025/0172315 A1
(43) Pub. Date: May 29, 2025

(54) REVERSIBLE ENERGY RECOVERY VENTILATOR AND METHOD OF OPERATING THE SAME

(71) Applicant: Broan-NuTone LLC, Hartford, WI (US)

(72) Inventors: Stephane Michaud, Drummondville (CA); Frederic Bazin, Drummondville (CA); Loic Ares, Drummondville (CA); Thomas Germain, Hartford, WI (US); Anthony Haman, Hartford, WI (US)

(21) Appl. No.: 18/959,806

(22) Filed: Nov. 26, 2024

Related U.S. Application Data
(60) Provisional application No. 63/602,753, filed on Nov. 27, 2023.

(51) Int. Cl. F24F 12/00; F24F 11/00; F24F 110/10; F24F 110/20

(52) U.S. Cl. CPC F24F 12/006; F24F 11/0001; F24F 2110/10; F24F 2110/20

(57) ABSTRACT

A ventilator for a building structure is disclosed. The ventilator has a housing defining (i) a first air flow plenum configured to be fluidly connected to the interior of the building at a first end and the exterior of the building at a second end, and (ii) a second air flow plenum configured to be fluidly connected to the interior of the building at a first end and the exterior of the building at a second end. A core defines portions of each of the first air flow plenum and the second air flow plenum and configured to transfer heat between the first air flow plenum and the second air flow plenum. A first sensor is located in the first air flow plenum to provide a sensed characteristic of the air in the first air flow plenum and a second sensor is located in the second air flow plenum to provide a sensed characteristic of the air in the second air flow plenum. A blower configured to move air through at least one of the first air flow plenum and the second air flow plenum. A switch provides a default designation of which the first air flow plenum and the second air flow plenum carries exhaust air from the interior of the building structure to the exterior of the building structure. A control system obtains readings from the first sensor and the second sensor indicative of a sensed characteristic of the air in the first air flow plenum and the second air flow plenum. The control system is configured to determine, based on the readings from the first sensor and the second sensor, which of the first air flow plenum and the second air flow plenum carries exhaust air from the interior of the building structure to the exterior of the building structure and compare the default designation of the switch to the determination based on the first and second sensors.

### PRIORITY

This application claims benefit under 35 U.S.C. § 119(e) to U.S. Provisional Application Ser. No. 63/602,753, filed Nov. 27, 2023, which is expressly incorporated by reference herein and made a part hereof.

### BACKGROUND

The present disclosure relates, generally, to heat recovery ventilators (HRV) and energy recovery ventilators (ERV). HRVs and ERVs may collectively be referenced herein as “recovery ventilators”. The present disclosure more particularly relates to system and method for determining which of the airflow paths defined in a recovery ventilator are configured to move stale indoor air (i.e. “exhaust air”) out of a building structure and which of the airflow paths defined in the recovery ventilator are configured to move fresh outdoor air (i.e. “supply air”) into the building structure.

Recovery ventilators may be used to regulate and maintain the air quality within a building structure by replacing exhaust air with supply air. HRVs and ERVs are two types of devices often utilized to exchange energy between the exhaust airflow and the supply airflow to recovery energy from the climate controlled exhaust air. In certain climates, the use of an ERV may be desirable over an HRV because an ERV allows moisture as well as heat to be exchanged between the exhaust air and the supply air.

Recovery ventilators utilize a core to accomplish the transfer of heat and/or humidity between the exhaust and supply air streams without allowing the air streams to mix. Some recover ventilators comprise stationary cores having substantially air impermeable membranes or plates. These membranes or plates separate the supply air from the exhaust air while allowing heat and, in the case of an ERV core, moisture to transfer from one side to the other, thus passing from one air stream to the other. Other recovery ventilators such as thermal wheels and accumulators are also known.

In order to properly operate various functions of a recovery ventilator, it is critical to identify which of the two airflows is the supply airflow and which is the exhaust airflow. In one example, recovery ventilators are often configured to periodically run a defrosting process intended to thaw any moisture that froze in the exhaust air stream (sometimes referenced herein as “defrost mode”). Defrost mode is sometimes accomplished by stopping the supply air flow while continuing the exhaust air flow so that heat from the exhaust air will thaw any moisture frozen in the core. Defrost mode has alternatively been accomplished by operating the recovery ventilator in recirculation mode, which prevents flow of any supply air into the recovery ventilator while circulating exhaust air through the core and back into the building structure. Typical recovery ventilators are pre-configured with one of the two plenums designated to conduct the supply airflow through the recovery ventilator and the other plenum designated to conduct the exhaust airflow through the recovery ventilator. Defrost mode can be accomplished in this typical recovery ventilator by preventing flow in the pre-designated supply airflow plenum while generating exhaust airflow through the pre-designated exhaust airflow plenum. Accordingly, installation of such a typical recovery vehicle requires proper connection of supply airflow ducting to the supply airflow plenum of the recovery ventilator and connection of exhaust airflow ducting to the exhaust airflow plenum of the recovery ventilator. Reversing the connection of the ducting and plenums in this typical recovery ventilator will prevent the recovery vehicle from operating properly in defrost mode.

Properly identifying which airflow is the supply airflow and which is the exhaust airflow is also important for other functions. For example, in some instances, it can be desirable or necessary to operate the recovery ventilator in a manner to bring more fresh air into the building structure than is exhausted from the building structure in order to increase the pressure inside the building structure relative to the air pressure outside the building structure. Conversely, in some instances it can desirable or necessary to operate the recovery ventilator in a manner to exhaust more air from the building structure than is brought into the building structure in order to decrease the pressure inside the building structure relative to the air pressure outside the building structure. In either instance, it is critical to know which flow path supplies fresh air and which exhaust stale air.

In another example, identifying which airflow is the supply airflow and which is the exhaust airflow is critical in instances in which the recovery ventilator is to be operated only to provide supply air, without exhausting air, in order to replace air exhausted by from the building structure by other exhaust mechanisms. Such replacement air is sometimes referred to as “make-up” air.

### SUMMARY

A ventilator for a building structure, the ventilator comprising a housing defining (i) a first air flow plenum configured to be fluidly connected to the interior of the building at a first end and the exterior of the building at a second end, and (ii) a second air flow plenum configured to be fluidly connected to the interior of the building at a first end and the exterior of the building at a second end; a core defining portions of each of the first air flow plenum and the second air flow plenum and configured to transfer heat between the first air flow plenum and the second air flow plenum; a first sensor located in the first air flow plenum to provide a sensed characteristic of the air in the first air flow plenum; a second sensor located in the second air flow plenum to provide a sensed characteristic of the air in the second air flow plenum; a blower configured to move air through at least one of the first air flow plenum and the second air flow plenum; a switch providing a default designation of which the first air flow plenum and the second air flow plenum carries exhaust air from the interior of the building structure to the exterior of the building structure; a control system for obtaining readings from the first sensor and the second sensor indicative of a sensed characteristic of the air in the first air flow plenum and the second air flow plenum; wherein the control system is configured to determine, based on the readings from the first sensor and the second sensor, which of the first air flow plenum and the second air flow plenum carries exhaust air from the interior of the building structure to the exterior of the building structure; wherein the control system is configured to compare the default designation of the switch to the determination based on the first and second sensors. The first and second sensors can be temperature sensors and the control system can determine that the first air flow plenum carries exhaust air from the interior of the building structure to the exterior of the building structure if the first temperature sensor indicates a higher temperature than the second temperature sensor. The first and second sensors can be temperature sensors and the control system can determine that the first air flow plenum carries exhaust air from the interior of the building structure to the exterior of the building structure if the first temperature sensor indicates a temperature that consistently remains in a range of approximately 60-77° F. (˜16-25° C.) over a predetermined period of time, but the second temperature sensor indicates a temperature that strays outside of the range during the predetermined period of time. The first and second sensors can be temperature sensors and the control system can determine that the first air flow plenum carries exhaust air from the interior of the building structure to the exterior of the building structure if the first temperature sensor indicates a maximum temperature fluctuation during a predetermined period of time not exceeding a predetermined delta threshold. The predetermined delta threshold can be 10° F. The first and second sensors can be temperature sensors and the control system can determine that the first air flow plenum carries exhaust air from the interior of the building structure to the exterior of the building structure if the first temperature sensor indicates a first temperature trend during a predetermined period of time and the second temperature sensor indicates a second temperature trend during the predetermined period of time and the second temperature trend is approximately the same as the first temperature trend, but the second temperature trend occurs after the first temperature trend. The control system can run a defrost mode based on the designations of the first airflow plenum and the second airflow plenum. The first and second sensors can be pollutant sensors. The switch can be one of a physical switch and a software switch.

A ventilator for a building structure, the ventilator comprising a housing defining (i) a first air flow plenum configured to be fluidly connected to the interior of the building at a first end and the exterior of the building at a second end, and (ii) a second air flow plenum configured to be fluidly connected to the interior of the building at a first end and the exterior of the building at a second end; a core defining portions of each of the first air flow plenum and the second air flow plenum and configured to transfer heat between the first air flow plenum and the second air flow plenum; a first blower configured to move air through the first air flow plenum; a second blower configured to move air through the second air flow plenum; a control system configured to: obtain a reading from the first blower indicative of one or more of the power, torque or RPM of the first blower; obtain a reading from the second blower indicative of one or more of the power, torque or RPM of the second blower; and determine, based on the readings from the first blower and the second blower, which of the first blower and the second blower carries exhaust air from the interior of the building structure to the exterior of the building structure.

A method of operating a ventilator having a housing defining (i) a first air flow plenum configured to be fluidly connected to the interior of the building at a first end and the exterior of the building at a second end, and (ii) a second air flow plenum configured to be fluidly connected to the interior of the building at a first end and the exterior of the building at a second end, the method comprising: obtaining a characteristic of the air in the first air flow plenum; obtaining a characteristic of the air in the in the second air flow plenum; operating a control system to determine, based on the obtained characteristics of the air in the first air flow plenum and the second air flow plenum, which of the first air flow plenum and the second air flow plenum carries exhaust air from the interior of the building structure to the exterior of the building structure; obtaining from a switch a default designation of which the first air flow plenum and the second air flow plenum carries exhaust air from the interior of the building structure to the exterior of the building structure; operating the control system to compare the compare the default designation to the determination, based on the obtained characteristics, of which of the first air flow plenum and the second air flow plenum carries exhaust air from the interior of the building structure to the exterior of the building structure. The obtained characteristics of the air can be temperature and the control system can determine that the first air flow plenum carries exhaust air from the interior of the building structure to the exterior of the building structure if the first temperature sensor indicates a higher temperature than the second temperature sensor. The obtained characteristics of the air can be temperature and the control system can determine that the first air flow plenum carries exhaust air from the interior of the building structure to the exterior of the building structure if the first temperature sensor indicates a temperature that consistently remains in a range of approximately 60-77° F. (˜16-25° C.) over a predetermined period of time, but the second temperature sensor indicates a temperature that strays outside of the range during the predetermined period of time. The obtained characteristics of the air can be temperature and the control system can determine that the first air flow plenum carries exhaust air from the interior of the building structure to the exterior of the building structure if the first temperature sensor indicates a maximum temperature fluctuation during a predetermined period of time not exceeding a predetermined delta threshold. The predetermined delta threshold can be 10° F. The obtained characteristics of the air can be temperature and the control system can determine that the first air flow plenum carries exhaust air from the interior of the building structure to the exterior of the building structure if the first temperature sensor indicates a first temperature trend during a predetermined period of time and the second temperature sensor indicates a second temperature trend during the predetermined period of time and the second temperature trend is approximately the same as the first temperature trend, but the second temperature trend occurs after the first temperature trend. A defrost mode can be run based on the designations of the first airflow plenum and the second airflow plenum. The characteristic of the air can be pollutants. The characteristic of the air can be humidity. The control system can be operated to change the default designation if the default designation differs from the determination based on the obtained characteristics.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A is a top plan view of an exemplary recovery ventilator configured to operate in a first configuration having one airflow plenum designated as the supply airflow plenum and the other as the exhaust airflow plenum.

FIG. 1B is a top plan view of the recovery ventilator of FIG. 1A configured to operate in a second configuration with the designation of the plenums reversed from those of FIG. 1A.

FIG. 2A is a plan view of the interior of the recovery vehicle of FIG. 1A, operated in the first configuration.

FIG. 2B is a perspective view of the interior of the recovery vehicle of FIG. 2A.

FIG. 2C is a plan view of the interior of the recovery vehicle of FIG. 1B, operated in the second configuration.

FIG. 3A is a flow chart showing logic for one exemplary method of determining which plenum contains supply air and which plenum contains exhaust air.

FIG. 3B is a flow chart showing logic for a second exemplary method of determining which plenum contains supply air and which plenum contains exhaust air.

FIG. 3C is a flow chart showing logic for a third exemplary method of determining which plenum contains supply air and which plenum contains exhaust air.

FIG. 3D is a flow chart showing logic for a fourth exemplary method of determining which plenum contains supply air and which plenum contains exhaust air.

FIG. 3E is a flow chart showing logic for a fifth exemplary method of determining which plenum contains supply air and which plenum contains exhaust air.

FIG. 3F is a flow chart showing logic for a sixth exemplary method of determining which plenum contains supply air and which plenum contains exhaust air.

FIG. 3G is a flow chart showing logic for a seventh exemplary method of determining which plenum contains supply air and which plenum contains exhaust air.

FIG. 3H is a flow chart showing logic for a eighth exemplary method of determining which plenum contains supply air and which plenum contains exhaust air.

FIG. 3I is a flow chart showing logic for a ninth exemplary method of determining which plenum contains supply air and which plenum contains exhaust air.

FIG. 4A depicts an exemplary floor plan showing two units in a multi-unit building and ducting run to a recovery ventilator in each unit in different configurations requiring cross-over of the ducting.

FIG. 4B depicts the floor plan of FIG. 4A and ducting run to a recovery ventilator in each unit in mirror configurations and not requiring crossover of the ducting.

FIG. 5 depicts several views of a manual switch to designate a default direction of flow for a recovery vehicle.

In one or more implementations, not all of the depicted components (including method steps) in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

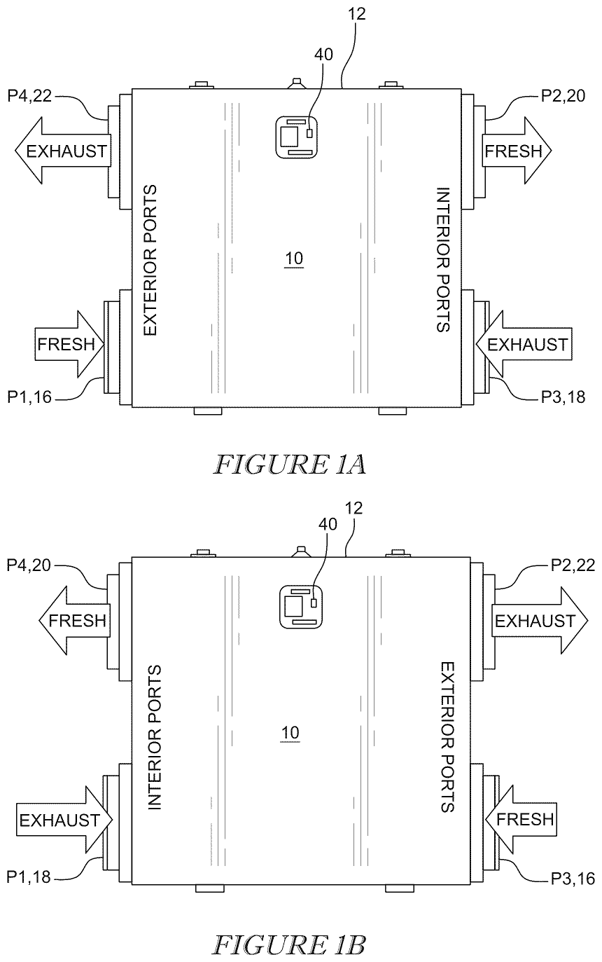

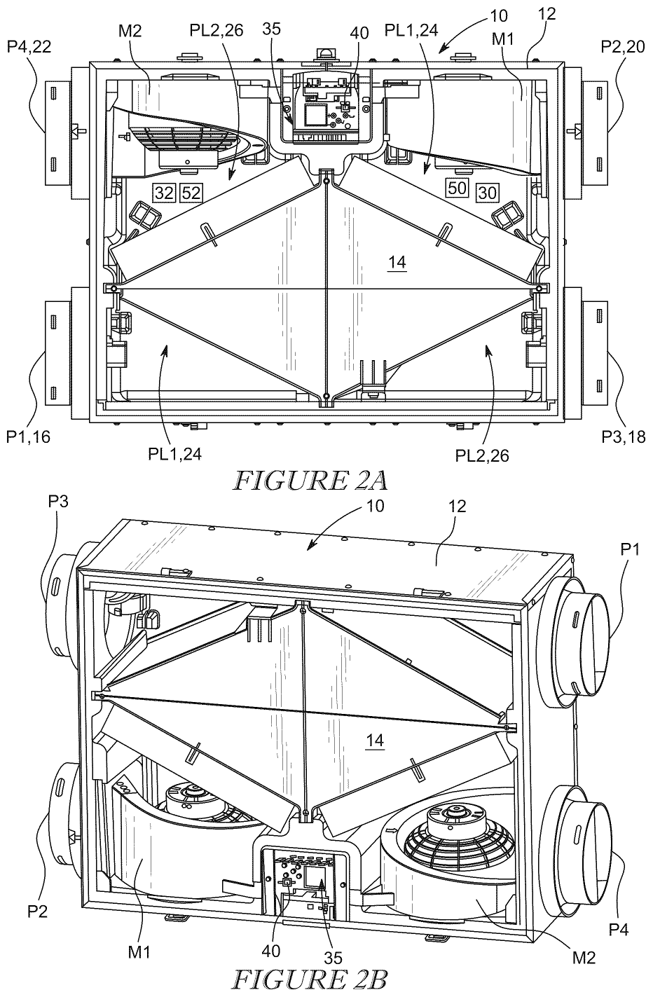

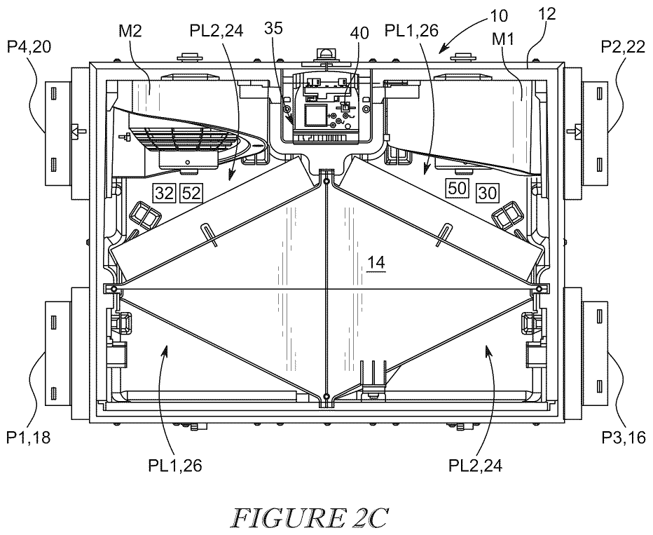

Referring now to the drawings, FIG. 1A depicts an exemplary recovery ventilator 10 (the terms “ventilator” and “vehicle” can be used interchangeably), having a housing 12 and a heat (or energy) recovery core 14 (see FIGS. 2A-2C) arranged in the housing 12. The housing 12 defines a first port P1 and a second port P2 arranged on either side of the core 14 and defining a first plenum PL1 therebetween to allow a first airflow through the housing 12 and the core 14. The housing 12 defines a third port P3 and a fourth port P4 arranged on either side of the core 14 and defining a second plenum PL2 therebetween to allow an second air flow through the housing 12 and the core 14. The core 14 is arranged along the first and second plenums PL1, PL2 to transfer heat and/or humidity between the first plenum PL1 and the second plenum PL2 without allowing the airflows themselves to mix. Some or all of the ports P1, P2, P3 and P4 may comprise a controllable damper to optionally restrict or prevent flow through the respective port.

A first blower M1 (see FIGS. 2A-2C) is located in the first plenum PL1 and configured to move the first airflow through the first plenum PL1. A second blower M2 (see FIGS. 2A-2C) is located in the second plenum PL2 and configured to move the second airflow through the second plenum PL2. The blowers M1, M2 are depicted as situated inside the housing 12, but can be located elsewhere so long as they are capable of providing the desired air movement. In some embodiments, only one blower may be included.

When the HRV/ERV 10 is installed to ventilate a building structure, some or all of the first port, P1, second port P2, third port P3 and fourth port P4 are typically connected to various ducting such that each defines one of a supply air inlet port 16, an exhaust air inlet port 18, a supply air outlet port 20, and an exhaust air outlet port 22. As a result, the first plenum PL1 and second plenum PL2 each constitute one of a supply air plenum 24 and an exhaust air plenum 26.

A first temperature sensor 30 is positioned in the first plenum PL1 to be exposed to the first airflow and provide temperature readings of the air in the first plenum PL1. A second temperature sensor 32 is positioned in the second plenum PL2 be exposed to the second airflow and provide temperature readings of the air in the second plenum PL2. The temperature sensors 30, 32 are located on opposite sides of the housing 12 so that one is located on the side of the housing 12 adjacent the interior of the ventilated structure and one is located on the side of the housing 12 adjacent to the exterior of the ventilated structure. In one embodiment, the temperature sensors 30, 32 are located on the housing 12, as depicted in FIGS. 2A, 2B, between the core 14 and the respective first and second blowers M1, M2. In another embodiment, the first and second temperature sensors 30, 32 are secured to the core 14. In an additional embodiment, the first and second temperature sensors 30, 32 are secured to the first and second blowers M1, M2 respectively; either internally or externally to the blowers M1, M2. In yet another embodiment, the first and second temperature sensors 30, 32 are secured to the inlet ports 16, 18 or to the outlet ports 20, 22. Other locations of the first and second temperature sensors 30, 32 are also contemplated to serve the function of providing the temperatures of the air in the first and second plenums PL1, PL2.

A control system 35 is provided to obtain readings from the first and second temperature sensors 30, 32 to identify the air temperature at the locations of those sensors 30, 32. The control system 35 runs an algorithm to determine, based on at least these temperature readings, which of the first and second plenums PL1, PL2 is the supply air plenum 24 and which is the exhaust air plenum 26. With this information, the control system 35 designates each of the plenums PL1, PL2 a designation consistent with the determined airflow. In one example, FIG. 2A depicts a configuration in which the first plenum PL1 has been detected as the supply air plenum 24 and designated as such and the second plenum PL2 has been detected as the exhaust air plenum 26 and designated as such. As a result, the first port P1 necessarily constitutes the supply air inlet port 16, the second port P2 constitutes the supply air outlet port 20, the third port P3 constitutes the exhaust air inlet port 18 and the fourth port P4 constitutes the exhaust air outlet port 22. With the plenums PL1, PL2 and ports P1, P2, P3, P4 designated correctly, a defrost mode can be run correctly by closing the supply air inlet port P1, 16, and/or by stopping operation of the blower in the supply air plenum 24, so that exhaust airflow can run through the core 14 via the second plenum PL2 to thaw the core 14.

FIG. 2C depicts the same recovery vehicle 10 as FIG. 2A except that the recovery vehicle 10 has been detected to be installed in a second configuration, which is the reverse of the first configuration in which the recovery vehicle 10 was installed in FIG. 2A. Thus, with the recovery vehicle 10 in FIG. 2C, first plenum PL1 becomes the exhaust air plenum 26 and the second plenum PL2 becomes the supply air plenum 24. The first port P1 becomes the exhaust air inlet port 18, the second port P2 becomes the exhaust air outlet port 22, the third port P3 becomes the supply air inlet port 16 and the fourth port P4 becomes the supply air outlet port 20. With the plenums PL1, PL2 and ports P1, P2, P3, P4 designated correctly, a defrost mode can be run correctly by closing the supply air inlet port P3, 16 so that exhaust airflow can run through the core 14 via the first plenum PL1 to thaw the core 14.

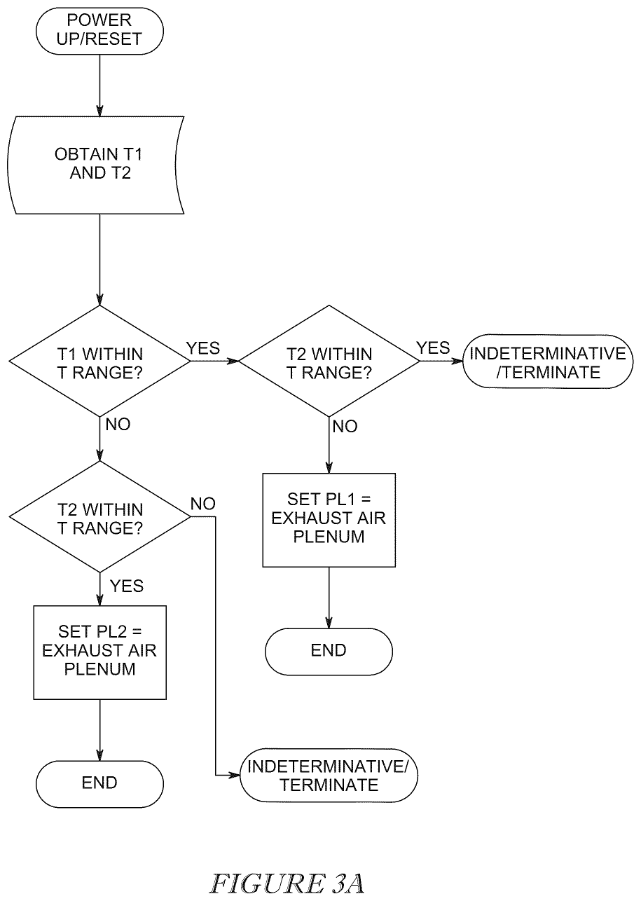

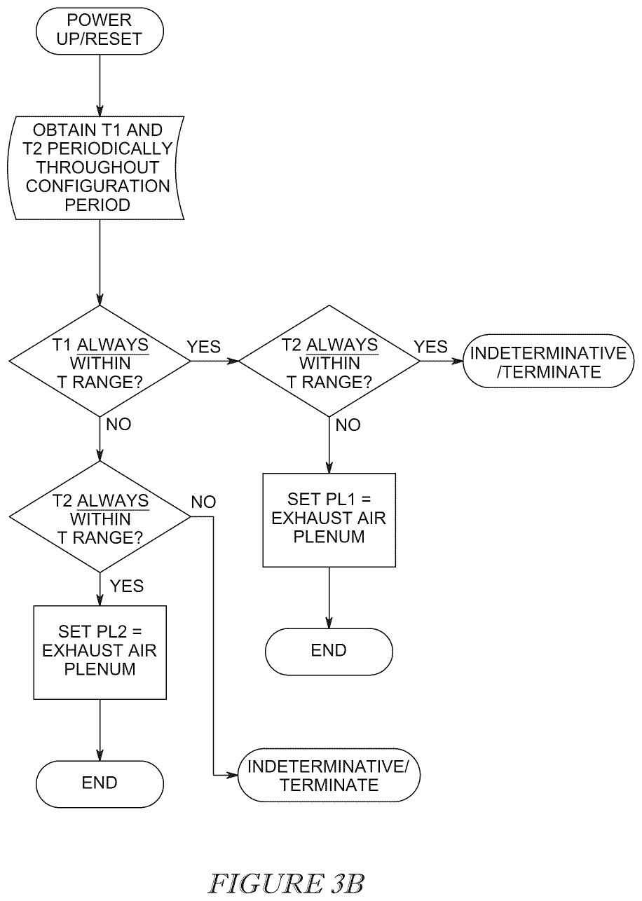

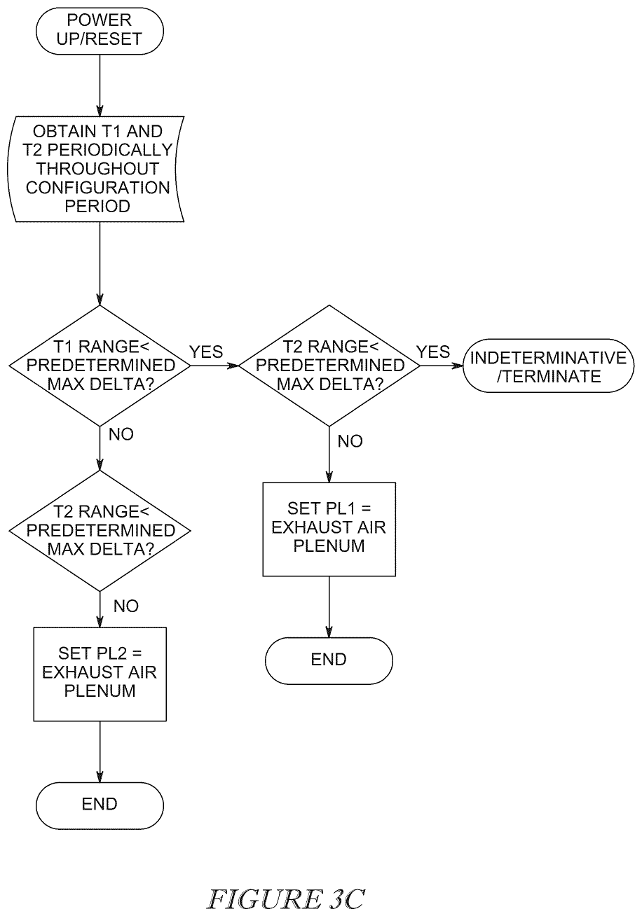

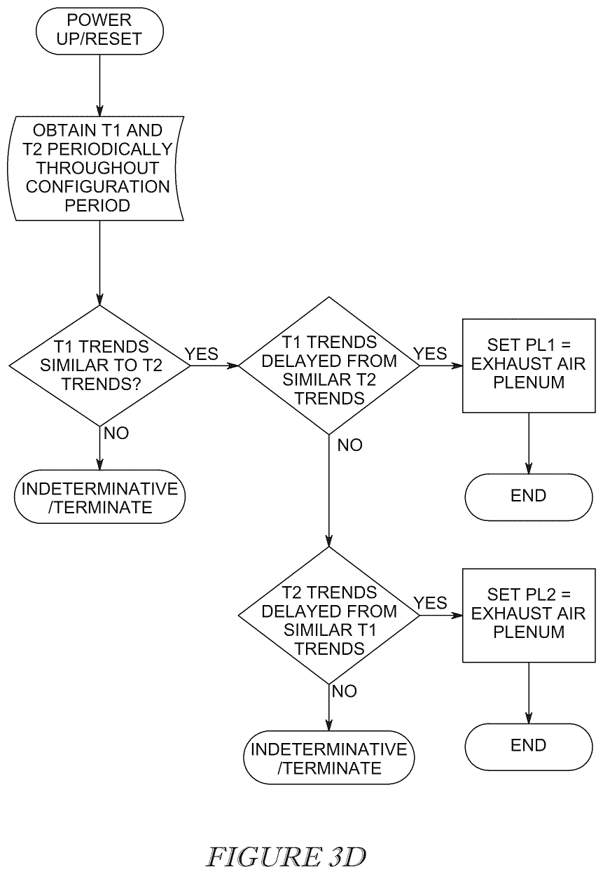

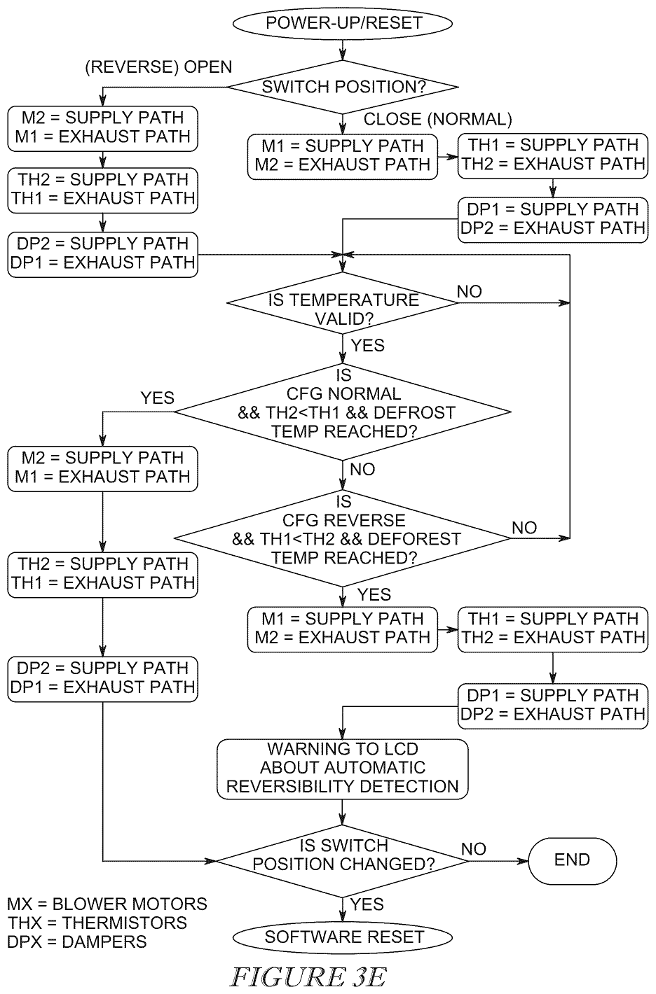

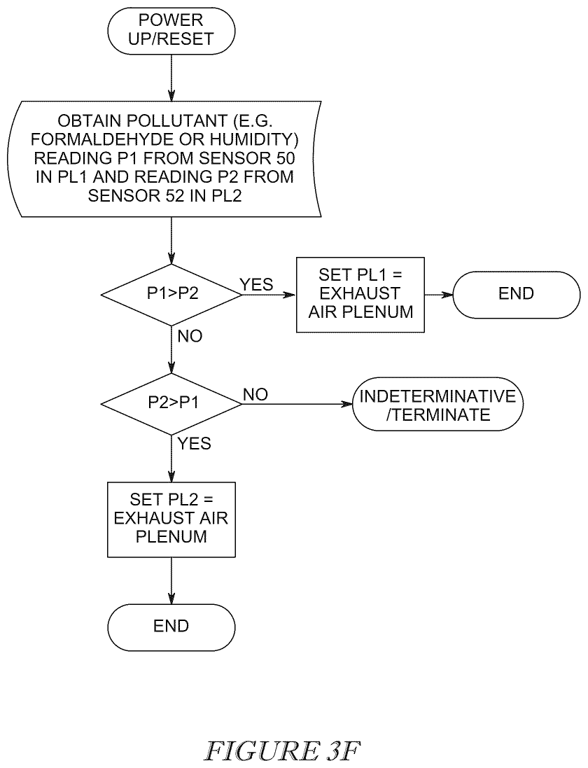

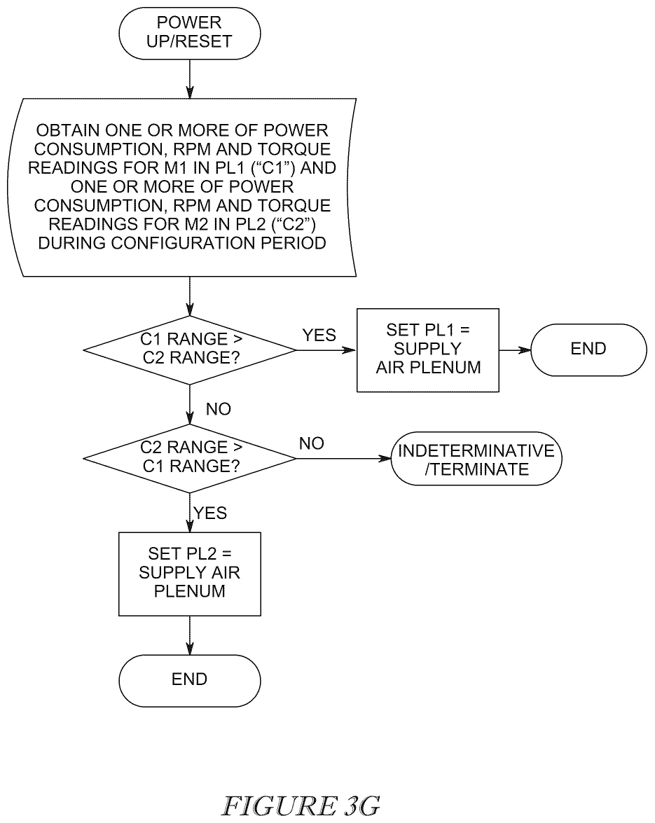

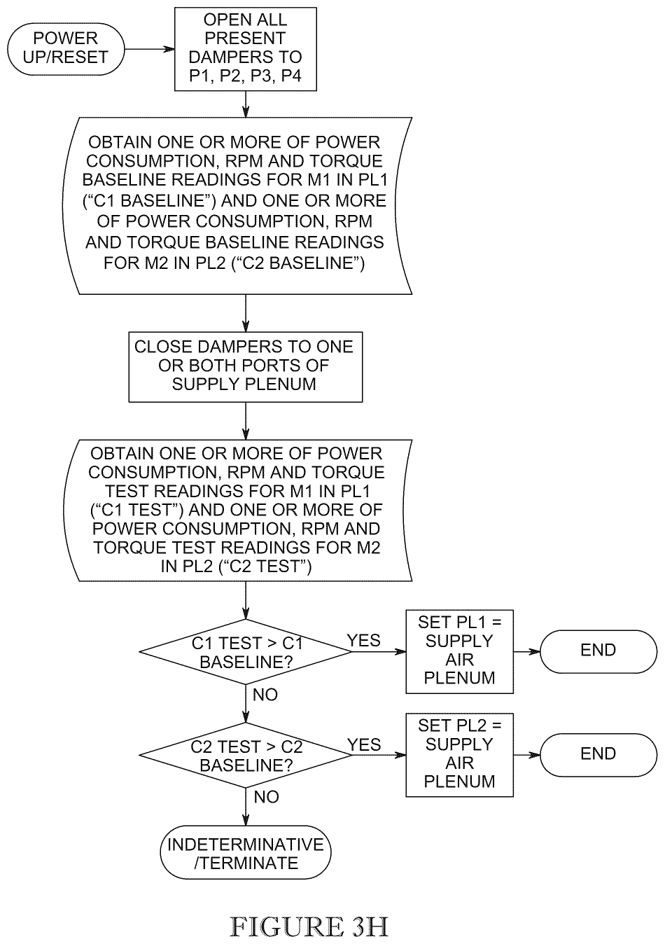

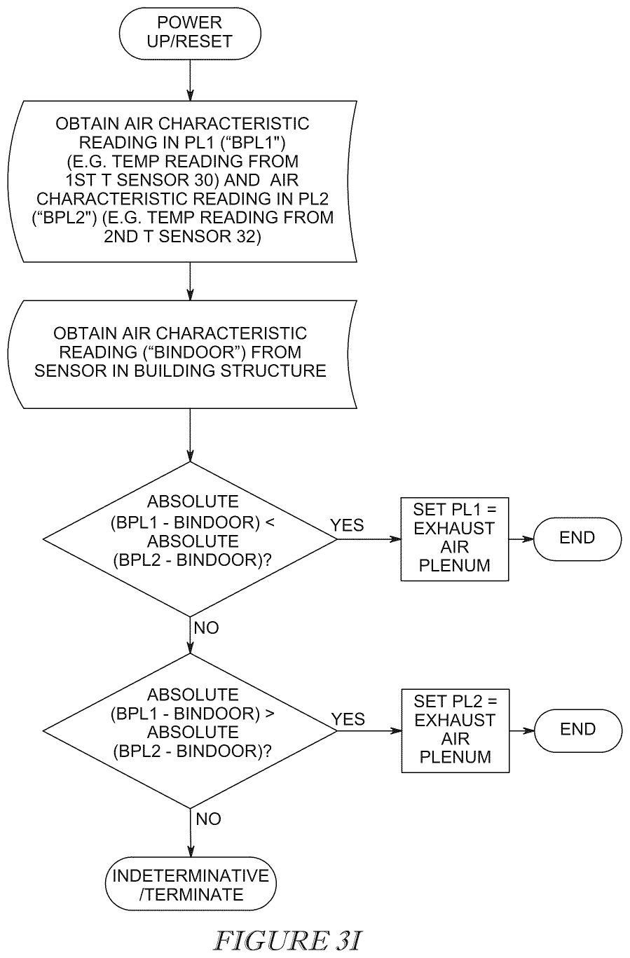

FIG. 3A depicts a first exemplary algorithm configured to be executed by the control system 35 to identify, based on readings from the first and second temperature sensors 30, 32, which of the first and second plenums PL1, PL2 is the supply air plenum 24 and which is the exhaust air plenum 26. This first exemplary algorithm obtains the temperatures identified by the first and second temperatures sensors 30, 32 when the HRV/ERV 10 is powered up and determines whether or not one of the two temperatures is in the range of approximately 60-77° F. (˜16-25° C.), which is the normal range of a climate controlled structure for humans. If only one of the two temperatures falls in that range, then the temperature sensor that provided those temperature readings is in the exhaust air plenum 26 and the exhaust air inlet port 18 and the exhaust air outlet port 22 can be determined based on the direction the first and second blowers M1, M2 are operating. If both temperature sensors 30, 32 provide readings in the range of approximately 60-77° F. (˜16-25° C.), then this algorithm alone cannot identify the ports with a reasonable certainty. This algorithm can be run each time the recovery vehicle 10 is powered up and/or each time the control system 35 is rebooted.

FIG. 3B depicts a second exemplary algorithm used by the control system 35 to identify which of the first and second plenums PL1, PL2 is the supply air plenum 24 and which is the exhaust air plenum 26. This second exemplary algorithm is similar to the first exemplary algorithm discussed above, except that it operates the recovery vehicle 10 in a default direction during a configuration period for a preset period of time (e.g. 24, 48 or 72 hours) periodically identifying temperatures sensed by the first and second temperature sensors 30, 32. The default direction can be set by the control system 35 or by an optional manual directional switch 40. The algorithm then identifies whether or not the readings from one of the two temperature sensors 30, 32 consistently remains in the range of approximately 60-77° F. (˜16-25° C.), while the other strays outside of that range from time to time during the configuration period. If only one of the two temperature sensors 30, 32 consistently stays in that range throughout the configuration period, then that temperature sensor is in the exhaust air plenum 26 and the exhaust air inlet port 18 and the exhaust air outlet port 22 can be determined based on the direction the first and second blowers M1, M2 are operating. In a variation on this second exemplary algorithm, identifying that only one of the two temperature sensors 30, 32 readings dipping below 50° F. (10° C.) or above 86° F. (30° C.) during the configuration period would identify the plenum in which that sensor resides as the supply air plenum 24.

FIG. 3C depicts a third exemplary algorithm used by the control system 35 to identify, which of the first and second plenums PL1, PL2 is the supply air plenum 24 and which is the exhaust air plenum 26. In this third exemplary algorithm, the recovery vehicle 10 runs a configuration period, as discussed above, for a preset period of time (e.g. 24, 48 or 72 hours) periodically identifying temperatures sensed by the first and second temperature sensors 30, 32. The algorithm then identifies whether or not the readings from one of the two temperature sensors 30, 32 varies more than a predetermined maximum delta from its highest temperature to its lowest temperature during the configuration period. The predetermined maximum delta could be, for example, a variation 15° F. (˜10° C.). Other preset deltas could be 10° F., 20° F. or other ranges typical of a climate controlled structure for humans. If only one of the two temperature sensors consistently stays within the predetermined maximum delta throughout the configuration period, then that temperature sensor is in the exhaust air plenum 26.

FIG. 3D depicts a fourth exemplary algorithm used by the control system 35 to identify which of the first and second plenums PL1, PL2 is the supply air plenum 24 and which is the exhaust air plenum 26. In this fourth exemplary algorithm, the recovery vehicle 10 runs a configuration period, as discussed above, for a preset period of time (e.g. 24, 48 or 72 hours) periodically identifying temperatures sensed by the first and second temperature sensors 30, 32. It has been found that temperature trends inside building structures climate controlled for humans typically follow exterior temperature trends, but with a delay. Thus, the fourth algorithm identifies trends in the readings from the first and second temperature sensors 30, 32 during the configuration period to see if similar trends can be identified with the trends from one of the first and second temperature sensors 30, 32 following the other with some delay. If one of the first and second temperature sensors 30, 32 reports one or more trends similar to, but delayed from, the other of the temperature sensor 30, 32, then the temperature sensor 30, 32 reporting the delayed trend is in the exhaust air plenum 26.

The control system 35 could run any one or more of the above algorithms to determine which of the first and second plenums PL1, PL2 is the supply air plenum 24 and which is the exhaust air plenum 26. Regardless of which one or ones of the algorithms is run, once the first and second plenums PL1, PL2 have been properly identified by the algorithm as the supply air plenum 24 and the exhaust air plenum 26, the control system 35 can properly execute a defrost mode when necessary. The recovery vehicle 10 then continues to operate with these plenum designations until the recovery vehicle 10 is shut down and turned back on or the control system 35 otherwise reset, at which time the algorithm(s) may be run again.

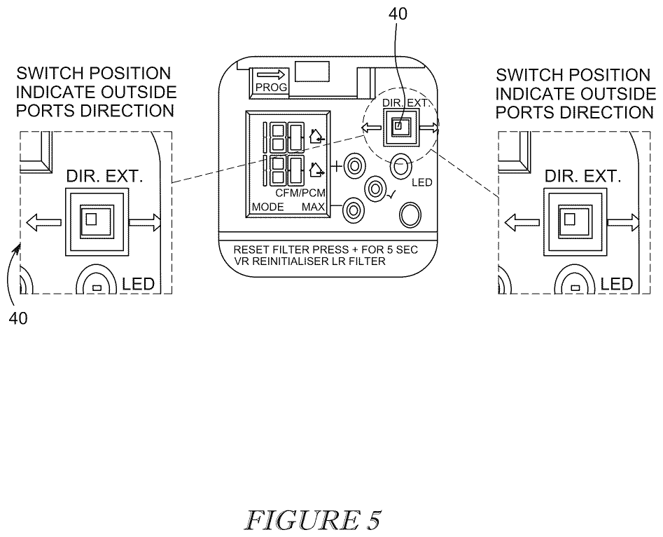

The recovery vehicle 10 optionally comprises the above mentioned manual directional switch 40 for an installer to manually configure which of the first and second plenums PL1, PL2 is the supply air plenum 24 and which is the exhaust air plenum 26. One exemplary manual directional switch 40 is depicted in FIG. 5 showing two possible alternative directions to select. The manual directional switch 40 depicted in FIG. 5 is marked with an indicator “DIR EXT” alerting the installer to move the switch toward the exterior of the structure in which the recovery vehicle 10 is installed, which would properly designate the first and second plenums PL1, PL2. A recovery vehicle 10 having this optional manual directional switch 40 will also include the control system 35 to run one or more of the above-discussed algorithms to verify, and where necessary correct, the indication of the manual directional switch. If present, the manual directional switch 40 will dictate the default designations of the first and second plenums PL1, PL2. Although the manual directional switch 40 is depicted as a physical switch, alternative switches are contemplated. The manual directional switch 40 can be used as a default capable of being overridden or changed by any algorithm disclosed herein.

FIG. 3E depicts a fifth exemplary algorithm used by the control system 35 to identify which of the first and second plenums PL1, PL2 is the supply air plenum 24 and which is the exhaust air plenum 26. In this fifth exemplary algorithm, the recovery vehicle 10 includes the manual directional switch 40 and the recovery vehicle 10 runs a configuration period for a preset period of time (e.g. 24, 48 or 72 hours) in the direction dictated by the manual directional switch 40, periodically identifying temperatures sensed by the first and second temperature sensors 30, 32. If the algorithm(s) indicates, based on any of the previously discussed methods, that the manual directional switch 40 has selected the correct configuration, then the recovery 10 continues operation in that configuration. If, however, the algorithm(s) indicates that the manual directional switch 40 has selected the incorrect configuration, then the control system 35 reconfigures its settings to correctly designate which of the first and second plenums PL1, PL2 is the supply air plenum 24 and which is the exhaust air plenum 26.

Additionally, this fifth exemplary algorithm includes a validity check on the temperature readings (i.e. “Is temperature valid?”); which is one of the many possible additional steps for any of the algorithms disclosed herein. In one embodiment, the temperature validity check discards temperature readings taken when the recovery vehicle 10 is in defrost mode. In another embodiment, the temperature validity check discards temperature reading taken when the recovery vehicle 10 is intentionally run with an unbalanced flow (e.g. supply flow greater than exhaust flow). In yet another embodiment, the temperature validity check discards temperature reading taken when the recovery vehicle 10 is run in a recirculation mode. In a further embodiment, the temperature validity check discards temperature readings taken during the first minutes (e.g. 5 minutes) of operation of the recovery vehicle 10 to allow the thermal mass of the recovery vehicle 10 and associated system (e.g. ducting) to balance with the ambient temperatures so that accurate temperature readings can be obtained by the first and second temperature sensors 30, 32.

A sixth exemplary algorithm used by the control system 35 to identify which of the first and second plenums PL1, PL2 is the supply air plenum 24 and which is the exhaust air plenum 26 uses one or more of a first pollutant sensor 50 and a second pollutant sensor 52. The first pollutant sensor 50 can replace the first temperature sensor 30 or be positioned anywhere in the first plenum PL1, including at, or adjacent to, the location of the first temperature sensor 30 in the first plenum PL1. The second pollutant sensor 52 can replace the second temperature sensor 32 or be positioned anywhere in the second plenum PL2, including at, or adjacent to, the location of the second temperature sensor 32 in the second plenum PL2. In this sixth exemplary algorithm, the recovery vehicle 10 runs a configuration period for a preset period of time (e.g. 24, 48 or 72 hours) periodically identifying levels of one or more air pollutants sensed by the first and second pollutant sensors 50, 52. In one example, the configuration period could be run for a preset period of time equal to the time necessary to take a single reading from the first and second pollutant sensors 50, 52.

It has been found that certain pollutants are emitted from some household products and building materials that cause air within a building structure to have levels of those pollutants which are barely present, or not present at all, in fresh air outside of the building structure. Thus, the sixth algorithm identifies which of the first and second pollutant sensors 50, 52 during the configuration period identify air pollutants indicative of indoor air and which of the first and second pollutant sensors 50, 52 does not identify those air pollutants. The sixth algorithm then designates as the exhaust air plenum 26, (i) whichever of the first and second plenums PL1, PL2 contains the one of the first and second pollutant sensors 50, 52 that sensed air pollutants or (ii) whichever of the first and second plenums PL1, PL2 contains the one of the first and second pollutant sensors 50, 52 that sensed more of the pollutant as depicted in exemplary FIG. 3F.

In an alternative embodiment of this algorithm, only a single pollutant sensor is used and is placed in either of the first and second plenums PL1, PL2. If that single pollutant sensor (e.g. first pollutant sensor 50 or second pollutant sensor 52) identifies a threshold level of the pollutant, then whichever of the first and second plenums PL1, PL2 contains that single pollutant sensor is designated as the exhaust air plenum 26. If, however, that single pollutant sensor does not identity a threshold level of the pollutant, then whichever of the first and second plenums PL1, PL2 contains that single pollutant sensor is designated as the supply air plenum 24.

In one embodiment, one or more of the air pollutant sensors described herein are configured to sense volatile organic compounds (“VOC) typically associated with household products and building materials. In one example, the air pollutant sensors are configured to sense formaldehyde. In another embodiment, one or more of the air pollutant sensors are configured to sense humidity.

A seventh exemplary algorithm used by the control system 35 to identify which of the first and second plenums PL1, PL2 is the supply air plenum 24 and which is the exhaust air plenum 26 monitors the power consumption, RPM and/or torque of each of the first and second blowers M1, M2. In this seventh exemplary algorithm, the recovery vehicle 10 runs a configuration period for a preset period of time (e.g. 24, 48 or 72 hours) periodically identifying one or more of the power consumption, RPM and torque of each of the first and second blowers M1, M2. It has been found that variations in temperature of air will change the density of that air. It has also been found that most blowers will function differently based on the density of the air being moved by the blower. Thus, variations in functionality of a blower can be indicative of changes in the temperature of the air being moved by that blower. Accordingly, changes in power consumption, RPM and/or torque of either of the first and second blowers M1, M2 during the configuration period can be indicative of changes in the temperature of the air in whichever of the first and second plenums PL1, PL2 houses the blower M1, M2 experiencing those changes. Thus, the seventh algorithm identifies which of the first and second blowers M1, M2 during the configuration period experiences greater changes in power consumption, RPM and/or torque. Using similar logic to the third algorithm depicted in FIG. 3C, the seventh algorithm then designates as the supply air plenum 24, whichever of the first and second plenums PL1, PL2 contains the one of the first and second blowers M1, M2 that experienced the greater changes in power consumption, RPM and/or torque. One example of this seventh algorithm is depicted in FIG. 3G.

An eighth exemplary algorithm used by the control system 35 to identify which of the first and second plenums PL1, PL2 is the supply air plenum 24 and which is the exhaust air plenum 26 uses a damper to obstruct air flow through one of the first and second plenums PL1, PL2 and monitors the power consumption, RPM and/or torque of each of the first and second blowers M1, M2 while the damper obstructs that one flow path. In this eighth exemplary algorithm, the recovery vehicle 10 runs a configuration period for a preset period of time with a damper obstructing flow in either the first or second plenum PL1, PL2 while monitoring the power consumption, RPM and/or torque of each of the first and second blowers M1, M2. Whichever of the first and second blowers M1, M2 requires more power, etc. is in the plenum obstructed by the damper. If, for example, the damper is in the exhaust flow path, then the blower requiring more power, etc. during this configuration period is the blower in the exhaust air plenum 26. Conversely, if the damper is in the supply flow path, then the blower requiring more power, etc. during this configuration period is the blower in the supply air plenum 24. Alternatively, monitoring the power consumption, RPM and/or torque of each of the first and second blowers M1, M2 before the damper is closed and during the closing of the damper will identify which blower is in the same flow path as the damper because that blower will experience changes in power consumption, RPM and/or torque when the damper is closed. The damper can be in the first or second plenum PL1, PL2 or anywhere along the flow paths, including outside of the recovery vehicle 10. One example of this eighth exemplary algorithm is depicted in FIG. 3H.

A ninth exemplary algorithm used by the control system 35 to identify which of the first and second plenums PL1, PL2 is the supply air plenum 24 and which is the exhaust air plenum 26 uses an external sensor that is external to, and separate from, the recovery vehicle 10 to monitor one or more characteristics of the air located somewhere in the building structure in which the recovery vehicle 10 is installed. In one example, the external sensor is a temperature sensor and senses the temperature inside of the building structure. In this ninth exemplary algorithm, the recovery vehicle 10 runs a configuration period, as discussed above, for a preset period of time (e.g. 24, 48 or 72 hours) periodically identifying the temperature sensed by the external sensor and the temperature of one or both of the first and second temperature sensors 30, 32. The ninth algorithm identifies which of the readings from the first and second temperature sensors 30, 32 during the configuration period is closest to the reading from the external temperature sensor. The ninth algorithm then designates as the exhaust air plenum 26, whichever of the first and second plenums PL1, PL2 contains the one of the first and temperature sensors 30, 32 that provides a reading closest to the reading from the external sensor. One exemplary algorithm is depicted in FIG. 3I. Alternatively, the ninth algorithm may conversely designate as the supply air plenum 24, whichever of the first and second plenums PL1, PL2 contains the one of the first and temperature sensors 30, 32 that provides a reading most different from the reading from the external sensor.

The external sensor used in the ninth exemplary algorithm can be included in a wall control providing a user interface for operation of the recovery vehicle 10. Alternatively, the external sensor could be included in any other equipment associated with any Internal Air Quality (“IAQ”) system of which the recovery vehicle 10 is a part any IAQ system existing in the building structure.

The ninth exemplary algorithm described above could alternatively use an external sensor measuring any one or more characteristics (instead of or in addition to temperature) of the air inside the building structure and compare a reading of that characteristic of the inside air to a corresponding reading of that characteristic of the air in the first and/or second plenum PL1, PL2 by adding any necessary additional sensors to the first and second plenums PL1, PL2. The control system 35 can then identify which of the first and second plenums PL1, PL2 is the exhaust air plenum 26 by identifying which of the first and second plenum contains air having the closest readings to the reading of the external sensor. The following are non-exclusive, exemplary characteristics that could be measured by the external sensor for use in the ninth exemplary algorithm: humidity, concentration of particulate matters, SVOC, VOC, pollen, inorganic gas such as CO, CO2, NO, NO2, SO2, ozone.

A variation of this ninth exemplary embodiment comprises an external sensor located outside of the building structure in which the recovery vehicle 10 is installed to measure any one or more characteristics of the air outside of the building structure and compare a reading of that characteristic of the outside air to a corresponding reading of that characteristic of the air in the first and/or second plenum PL1, PL2 by adding any necessary additional sensors to the first and second plenums PL1, PL2. The control system 35 can then identify which of the first and second plenums PL1, PL2 is the supply air plenum 24 by identifying which of the first and second plenum contains air having the closest readings to the reading of the outdoor external sensor. In one embodiment, the readings from the external sensor located outside of the building structure can be replaced by data obtained from a nearby weather station or data from the internet.

Any two or more of the various algorithms described above can be combined in a recovery vehicle 10. In one example, any two of the algorithms described above can be used with the recovery vehicle 10 with each of the two algorithms independently determining which of the first and second plenums PL1, PL2 is the supply air plenum 24 and which is the exhaust air plenum 26. The results of the two algorithms can be compared to verify the accuracy of each. If the two algorithms reach different determinations of which of the first and second plenums PL1, PL2 is the supply air plenum 24 and which is the exhaust air plenum 26, then the results of one of the two algorithms perceived as the more reliable of the two may be used to designate the supply air plenum 24 and the exhaust air plenum 26 and the algorithms can, optionally, be re-run until the determinations are in agreement.

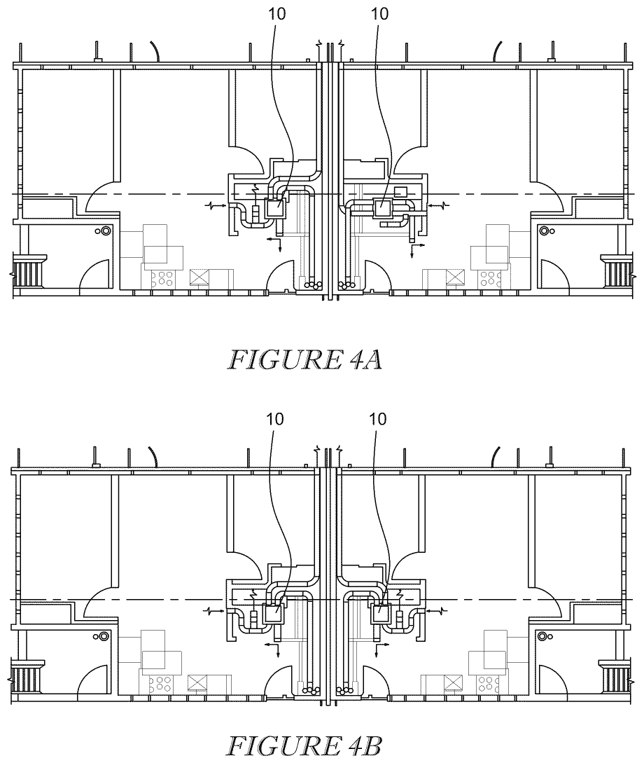

It has been found that the recovery vehicle 10 disclosed herein provides the benefit of allowing the recovery vehicle 10 to self-determine which of the first and second plenums PL1, PL2 is the supply air plenum 24 and which is the exhaust air plenum 26. This allows installation of the recovery vehicle 10 without concern about the recovery vehicle 10 being correctly installed. As illustrated by FIGS. 1A and 1B, the recovery vehicle 10 can be installed in the same orientation each time, without concern about the configuration in which it need run because either is possible and the control system 35 will determine and initiate the proper configuration. One beneficial application of the recovery vehicle 10 disclosed herein is illustrated in the exemplary floor plans depicted in FIGS. 4A and 4B. FIG. 4A depicts a floor plan for a multi-unit structure in which, as is common, two adjacent units have mirror configurations. FIG. 4A depicts each unit having a non-reversible recovery vehicle installed in the same configuration. Because the ports are all predesignated as being one of a supply air inlet port, a supply air outlet port, an exhaust air inlet port or an exhaust air outlet port and those designations cannot be changed, the ducting to and from the recovery vehicle is different for each of the two units and requires some of the ducting to cross over itself requiring extra space in the ceiling or floor. FIG. 4B, on the other hand, depicts the same multi-unit floor plane as depicted in FIG. 4A, but with each unit having the recovery vehicle 10 disclosed herein. Because the recovery vehicle 10 disclosed herein is reversible, the recovery vehicles 10 can be installed in the same orientation in each unit and the ducting to and from the recovery vehicles 10 can mirror each other, facilitating true mirror units, which simplifies planning, installation and inspection.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. In addition, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

In one aspect, a term coupled or the like may refer to being directly coupled. In another aspect, a term coupled or the like may refer to being indirectly coupled. Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The use of the terms “a” and “an” and “the” and “said” and similar references in the context of describing the invention (especially in the context of the following claims) are to be construed to cover both the singular and the plural, unless otherwise indicated herein or clearly contradicted by context. An element proceeded by “a,” “an,” “the,” or “said” does not, without further constraints, preclude the existence of additional same elements. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

We claim:

1. A ventilator for a building structure, the ventilator comprising:
a housing defining (i) a first air flow plenum configured to be fluidly connected to the interior of the building at a first end and the exterior of the building at a second end, and (ii) a second air flow plenum configured to be fluidly connected to the interior of the building at a first end and the exterior of the building at a second end;
a core defining portions of each of the first air flow plenum and the second air flow plenum and configured to transfer heat between the first air flow plenum and the second air flow plenum;
a first sensor located in the first air flow plenum to provide a sensed characteristic of the air in the first air flow plenum;
a second sensor located in the second air flow plenum to provide a sensed characteristic of the air in the second air flow plenum;
a blower configured to move air through at least one of the first air flow plenum and the second air flow plenum;
a switch providing a default designation of which the first air flow plenum and the second air flow plenum carries exhaust air from the interior of the building structure to the exterior of the building structure;
a control system for obtaining readings from the first sensor and the second sensor indicative of a sensed characteristic of the air in the first air flow plenum and the second air flow plenum;
wherein the control system is configured to determine, based on the readings from the first sensor and the second sensor, which of the first air flow plenum and the second air flow plenum carries exhaust air from the interior of the building structure to the exterior of the building structure;
wherein the control system is configured to compare the default designation of the switch to the determination based on the first and second sensors.

2. The ventilator of claim 1 wherein the first and second sensors are temperature sensors and the control system determines that the first air flow plenum carries exhaust air from the interior of the building structure to the exterior of the building structure if the first temperature sensor indicates a higher temperature than the second temperature sensor.

3. The ventilator of claim 1 wherein the first and second sensors are temperature sensors and the control system determines that the first air flow plenum carries exhaust air from the interior of the building structure to the exterior of the building structure if the first temperature sensor indicates a temperature that consistently remains in a range of approximately 60-77° F. (˜16-25° C.) over a predetermined period of time, but the second temperature sensor indicates a temperature that strays outside of the range during the predetermined period of time.

4. The ventilator of claim 1 wherein the first and second sensors are temperature sensors and the control system determines that the first air flow plenum carries exhaust air from the interior of the building structure to the exterior of the building structure if the first temperature sensor indicates a maximum temperature fluctuation during a predetermined period of time not exceeding a predetermined delta threshold.

5. The ventilator of claim 4 wherein the predetermined delta threshold is 10° F.

6. The ventilator of claim 1 wherein the first and second sensors are temperature sensors and the control system determines that the first air flow plenum carries exhaust air from the interior of the building structure to the exterior of the building structure if the first temperature sensor indicates a first temperature trend during a predetermined period of time and the second temperature sensor indicates a second temperature trend during the predetermined period of time and the second temperature trend is approximately the same as the first temperature trend, but the second temperature trend occurs after the first temperature trend.

7. The ventilator of claim 1 wherein the control system runs a defrost mode based on the designations of the first airflow plenum and the second airflow plenum.

8. The ventilator of claim 1 wherein the first and second sensors are pollutant sensors.

9. The ventilator of claim 1 wherein the switch is one of a physical switch and a software switch.

10. A ventilator for a building structure, the ventilator comprising:
a housing defining (i) a first air flow plenum configured to be fluidly connected to the interior of the building at a first end and the exterior of the building at a second end, and (ii) a second air flow plenum configured to be fluidly connected to the interior of the building at a first end and the exterior of the building at a second end;
a core defining portions of each of the first air flow plenum and the second air flow plenum and configured to transfer heat between the first air flow plenum and the second air flow plenum;
a first blower configured to move air through the first air flow plenum;
a second blower configured to move air through the second air flow plenum;
a control system configured to:
obtain a reading from the first blower indicative of one or more of the power, torque or RPM of the first blower;
obtain a reading from the second blower indicative of one or more of the power, torque or RPM of the second blower; and
determine, based on the readings from the first blower and the second blower, which of the first blower and the second blower carries exhaust air from the interior of the building structure to the exterior of the building structure.

11. A method of operating a ventilator having a housing defining (i) a first air flow plenum configured to be fluidly connected to the interior of the building at a first end and the exterior of the building at a second end, and (ii) a second air flow plenum configured to be fluidly connected to the interior of the building at a first end and the exterior of the building at a second end, the method comprising:
obtaining a characteristic of the air in the first air flow plenum;
obtaining a characteristic of the air in the in the second air flow plenum;
operating a control system to determine, based on the obtained characteristics of the air in the first air flow plenum and the second air flow plenum, which of the first air flow plenum and the second air flow plenum carries exhaust air from the interior of the building structure to the exterior of the building structure;
obtaining from a switch a default designation of which the first air flow plenum and the second air flow plenum carries exhaust air from the interior of the building structure to the exterior of the building structure;
operating the control system to compare the compare the default designation to the determination, based on the obtained characteristics, of which of the first air flow plenum and the second air flow plenum carries exhaust air from the interior of the building structure to the exterior of the building structure.

12. The method of claim 11 wherein the obtained characteristics of the air are temperature and the control system determines that the first air flow plenum carries exhaust air from the interior of the building structure to the exterior of the building structure if the first temperature sensor indicates a higher temperature than the second temperature sensor.

13. The method of claim 11 wherein the obtained characteristics of the air are temperature and the control system determines that the first air flow plenum carries exhaust air from the interior of the building structure to the exterior of the building structure if the first temperature sensor indicates a temperature that consistently remains in a range of approximately 60-77° F. (˜16-25° C.) over a predetermined period of time, but the second temperature sensor indicates a temperature that strays outside of the range during the predetermined period of time.

14. The method of claim 11 wherein the obtained characteristics of the air are temperature and the control system determines that the first air flow plenum carries exhaust air from the interior of the building structure to the exterior of the building structure if the first temperature sensor indicates a maximum temperature fluctuation during a predetermined period of time not exceeding a predetermined delta threshold.

15. The method of claim 14 wherein the predetermined delta threshold is 10° F.

16. The method of claim 11 wherein the obtained characteristics of the air are temperature and the control system determines that the first air flow plenum carries exhaust air from the interior of the building structure to the exterior of the building structure if the first temperature sensor indicates a first temperature trend during a predetermined period of time and the second temperature sensor indicates a second temperature trend during the predetermined period of time and the second temperature trend is approximately the same as the first temperature trend, but the second temperature trend occurs after the first temperature trend.

17. The method of claim 11 further including the step of running a defrost mode based on the designations of the first airflow plenum and the second airflow plenum.

18. The method of claim 11 wherein the characteristic of the air is pollutants.

19. The method of claim 11 wherein the characteristic of the air is humidity.

20. The method of claim 11 operating the control system to change the default designation if the default designation differs from the determination based on the obtained characteristics.
